(19) United States
(12) Patent Application Publication
(10) Pub. No.: US 2005/0271023 A1
(43) Pub. Date: Dec. 8, 2005

(54) System and method for providing a user-definable, removable media-based device name assigner

(76) Inventors: Robert J. Murphy, Belmont, CA (US); John Hanay, Palo Alto, CA (US)

Correspondence Address: Robert J. Murphy, 1152 Village Dr., Belmont, CA, 94002, US

(21) Appl. No.: 11/145,276

(22) Filed: Jun. 3, 2005

Related U.S. Application Data
(60) Provisional application No. 60/577,390, filed on Jun. 4, 2004.

(51) Int. Cl. H04L 12/28

(52) U.S. Cl. 370/338; 370/254

(57) ABSTRACT

The disclosed system and method provide a means for creating, installing and re-installing device names and unique identifiers onto one or more handheld devices using an assignment application residing on removable media in the absence of a desktop or laptop computer. A method of installing a device name on a handheld device includes the steps of (a) automatically launching an assignment application on the handheld device from a removable media; (b) selecting a device name stored on the removable media for installation; and (c) installing the selected device name on the handheld device using the assignment application. An administrative application is used to create the device names which are stored in a name group data structure including the device names and corresponding unique numeric identifiers. The name groups conform to formats of corresponding handheld devices.

### CROSS REFERENCE TO RELATED APPLICATIONS

The present application claims priority under 35 U.S.C. 119(e) from provisional patent application Ser. No. 60/577,390, entitled “User-Definable, Removable Media-Based, Device Name Assigner”, filed on Jun. 4, 2004, the disclosure of which is herein incorporated by reference in its entirety.

### BACKGROUND OF THE INVENTION

The present invention relates generally to configuration tools and more particularly to a user-definable, removable media-based, device name installer for creating, installing and re-installing device names and unique numeric identifiers onto one or more handheld devices using a configuration application residing on removable media in the absence of a desktop or laptop computer.

The use of configuration tools for installing device names and unique identifiers to handheld devices is well known in the art. Typically, configuration tools for handheld devices include data synchronization products such as HotSync Manager, available from PalmSource, Inc. of Sunnyvale, Calif., and ActiveSync, available from Microsoft Corporation of Redmond, Wash. These products allow a user to individually create and install device names and unique identifiers while the handheld device is connected to a computer. The creation of the device name and numeric identifier is performed using the computer and is installed during a synchronization process between the computer and the handheld device.

Prior art data synchronization products suffer the disadvantage of being designed with the intent that the handheld device is connected to a desktop or laptop computer with the data synchronization application running on the computer and data being transferred as part of a data synchronization operation. These products do not provide a means of installing device names and numeric identifiers onto handheld devices in the absence of a desktop or laptop computer. Another problem with conventional configuration tools is these tools were designed for individual use and do not lend themselves to easily creating large numbers of device names and assigning device names to large numbers of devices in an automated and efficient fashion. Another problem with conventional configuration tools is these tools do not provide a facility for importing a list of names from other name management systems and creating device names from those names, including the creation of corresponding unique numeric identifiers.

There is therefore a need in the art for a system and method for providing a user-definable, removable media-based, device name assigner which overcomes the disadvantages of the prior art. Preferably the system and method provide a means for creating, installing and re-installing device names and unique identifiers onto one or more devices using a configuration application residing on removable media in the absence of a desktop or laptop computer. The system and method also preferably provides a means for creating device names and unique numeric identifiers using a variety of methods including importing names from an external file, entering names one at a time, and creating a sequential list of names based upon a root name.

### SUMMARY OF THE INVENTION

In accordance with one aspect of the invention, a method of installing a device name on a handheld device includes the steps of (a) automatically launching an assignment application on the handheld device from a removable media; (b) selecting a device name stored on the removable media for installation; and (c) installing the selected device name on the handheld device using the assignment application.

In accordance with another aspect of the invention, a method of installing device names stored on a removable media onto a plurality of handheld devices includes the steps of (a) automatically launching an assignment application on a first handheld device from a removable media; (b) selecting a first device name for installation onto the first handheld device using the assignment application; (c) automatically installing the first device name onto the first handheld device using the assignment application; (d) selecting an auto-assign function from the assignment application; (e) automatically launching the assignment application on a next handheld device; (f) selecting a next device name for installation onto the next handheld device using the assignment application; (g) automatically installing the next device name onto the next handheld device using the assignment application; and (h) repeating steps (e)-(g).

In accordance with yet another aspect of the invention, a system for installing a device name on a handheld device includes a processor operable to (a) automatically launch an assignment application on the handheld device from a removable media; (b) select a device name stored on the removable media for installation; and (c) install the selected device name on the handheld device using the assignment application

In accordance with another aspect of the invention, a system for installing device names stored on a removable media onto a plurality of handheld devices includes a processor operable to (a) automatically launch an assignment application on a first handheld device from a removable media; (b) select a first device name for installation onto the first handheld device using the assignment application; (c) automatically install the first device name onto the first handheld device using the assignment application; (d) select an auto-assign function from the assignment application; (e) automatically launch the assignment application on a next handheld device; (f) select a next device name for installation onto the next handheld device using the assignment application; (g) automatically install the next device name onto the next handheld device using the assignment application; and (h) repeat steps (e)-(g).

There has been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended herein.

In this respect, before explaining at least one embodiment of the invention in detail, it is to be understood that the invention is not limited in its application to the details of design and to the sequence of steps and processes set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other methods and systems for carrying out the several purposes of the present invention. It is important, therefore, that the claims be regarded as including such equivalent methods and systems insofar as they do not depart from the spirit and scope of the present invention.

### BRIEF DESCRIPTION OF THE DRAWINGS

The present disclosure may be better understood and its numerous features and advantages made apparent to those skilled in the art by referencing the accompanying drawings.

FIG. 1 is a schematic representation of a representative hardware environment in which the present invention may be practiced;

FIG. 2 is a flow diagram illustrating an administrative application in accordance with the present invention; and

FIG. 3 is a flow diagram illustrating an assignment application in accordance with the present invention.

### DETAILED DESCRIPTION OF THE INVENTION

The present invention relates to a system and method for providing a user-definable, removable media-based device name assigner. An administrative application may create and process the device names and unique numeric identifiers into a name group data structure for use by an assignment application. The name group data structure and the assignment application may reside on a removable media. The assignment application may display the device names contained in the name group data structure, allowing a user to select device names from the list, and configure a handheld device with the selected device name and unique numeric identifier. The administrative application may be used to create a list of device names, using a variety of methods including importing names from an external file, entering names one at a time, and creating a sequential list of names using a root name. The administrative application may generate a unique numeric identifier for each device name when the device names are processed into the name group data structure. The administrative application may provide a means for deleting one or more device names from the list.

Name groups may be comprised of a list of device names and corresponding unique numbers conforming to the prescribed format for the intended device. Removable media may include any type of media that is used by handheld devices to store data. The assignment application may include an application pre-installed on the removable media, used by the user to select a device name from a list of device names, and configure the handheld device with the selected device name and corresponding unique numeric identifier. The assignment application may launch when the removable media is inserted into the handheld device and can be configured to automatically install the next unused device name and unique numeric identifier when inserted into subsequent handheld devices.

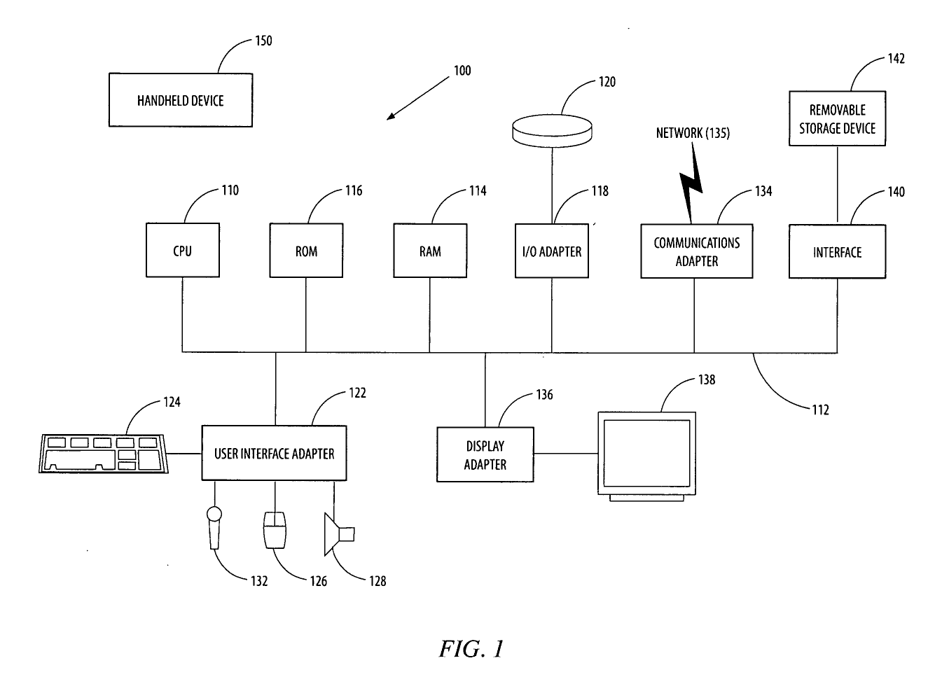

The present invention may be implemented using hardware, software, or a combination thereof and may be implemented in a computer system generally designated 100 or other processing system as shown in FIG. 1. In one aspect of the invention, the invention is directed toward the computer system 100 capable of carrying out the functionality described herein. The computer system 100 may include one or more processors 110. The processor 110 may be connected to a communication bus 112. Various software embodiments are described in terms of this exemplary computer system 100. After reading this description, it will become apparent to one skilled in the art how to implement the invention using other computer systems and/or computer architectures.

Computer system 100 may also include a main memory, preferably random access memory (RAM) 114, a read only memory (ROM) 116, and a secondary memory including a secondary memory drive 118 and a secondary memory device such as a magnetic or optical disk 120. Computer system 100 may also include an interface 140 such as a USB interface, a PCI Express interface, and an ExpressCard interface. The interface 140 may provide an interface to a removable storage device 142 such as a flash memory card. As will be appreciated, the removable storage device 142 may include a computer usable storage medium having stored therein computer software and/or data. Interface 140 may further allow software and data to be transferred from the removable storage device 142 to the computer system 100 and to a handheld device 150.

Computer system 100 may also include a communications adapter 134 for communication with a network 135 and remote devices such as the handheld device 150. Communications adapter 134 allows software and data to be transferred between the computer system 100 and external devices including storage devices and the handheld device 150. Examples of communications adapter 134 may include a modem, a network interface (such as an Ethernet card), a communications port, and a PCMCIA slot and card. Software and data transferred via communications adapter 134 are in the form of signals which can be electronic, electromagnetic, optical or other signals capable of being received by communications adapter 134. These signals are provided to the communications adapter 134 via a channel. The channel may carry signals and may be implemented using wire, cable, fiber optic cable, phone lines, cellular phone link, an RF link and other communications channels.

In this description, the terms “computer program medium” and “computer usable medium” are used to generally refer to media such as removable storage devices 142, the secondary memory device 120 including a hard disk installed in the secondary memory drive 118, and signals. These computer program products are means for providing software to the computer system 100 and the handheld device 150.

Computer programs and software applications (also called computer control logic) may be stored in main memory 114, secondary memory 120, and in the removable storage device 142. Computer programs may also be received via communications adapter 134. Such computer programs, when executed, enable the computer system 100 and the handheld device 150 to perform the features of the present invention as discussed herein. In particular, the computer programs, when executed enable the processor 110 and a handheld device processor (not shown) to perform the features of the present invention. Accordingly, such computer programs represent controllers of the computer system 100 and the handheld device 150.

In an embodiment where the invention is implemented using software, the software may be stored in a computer program product and loaded into the computer system 100 and handheld device 150 using the removable storage device 142 and/or communications adapter 134. The control logic (software), when executed by the processor 110 and handheld device processor, causes the processor 110 and handheld device processor to perform the functions of the invention as described herein. In one aspect of the invention, the administrative application may be stored in the RAM 114 or in the secondary memory 120 and the assignment application may be stored in the removable storage device 142.

In another aspect of the invention, the invention may be implemented primarily in hardware using, for example, hardware components such as application specific integrated circuits (ASICS). Implementation of the hardware state machine so as to perform the functions described herein will be apparent to persons skilled in the relevant art. In yet another embodiment, the invention may be implemented using a combination of both hardware and software.

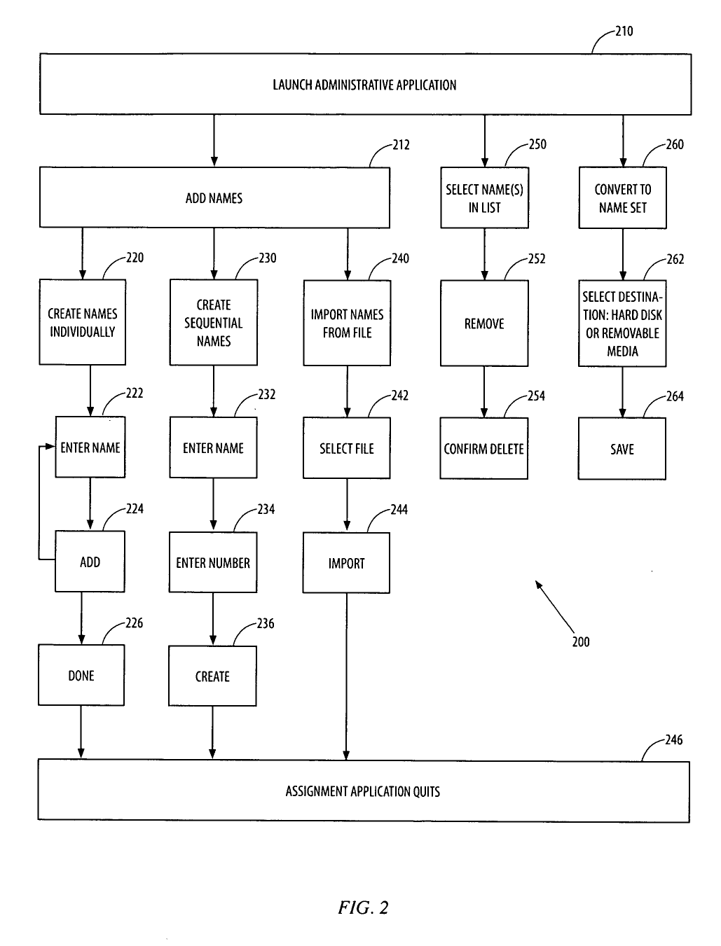

In one aspect of the invention, the administrative application may include a process generally designated 200 that provides a means for creating a list of device names, using a variety of methods including importing the list from an external file, entering the list individually, and creating a sequential list based upon a root name as shown in FIG. 2. Process 200 may include a step 210 in which the administrative application may be launched by the computer system 100. In a step 212, a user may create a list of device names which alternatively may be created individually in a process starting at a step 220, sequentially in a process starting at a step 230, and imported from an existing file in a step 240.

Process 220 may include a step 222 in which the user may enter a device name and a step 224 in which the user adds the device name to the list. Additional names may be added in steps 222 and 224. When the user completes entering device names, process 220 may be terminated in a step 226. The device names entered may be displayed in a list in a step 246. The displayed names may be displayed with the first entered device name at a top of the list and subsequent device names listed in the order in which they were entered.

Process 230 may include a step 232 in which the user may enter a root name and a step 234 in which the user may enter the number of devices to be named. A list of device names having a unique identifier appended to the root name may be created in a step 236 and displayed in the step 246. The device names may be displayed with the device names appearing in sequential order.

Process 240 may include a step 242 in which the user may create a list of device names by selecting a comma separated value (CSV) file containing a list of device names. In a step 244 the CSV file may be imported. The order of the imported list of device names may be preserved and the list displayed in the step 246.

The administrative application 200 may include a process for removing device names from a list. In a step 250 the user may select a device name or names for removal from the device name list. The device name or names may be removed in a step 252. In a step 254 the user may be prompted to confirm the deletion of the device name or names from the device name list.

The administrative application 200 may further include a process for converting the list of device names into a name group data structure in a step 260. A unique numeric identifier may be created for each device name. In a step 262 the user may select a destination where the name group data structure may be saved including removable storage device 142 and storage device 114. In a step 264, the name group data structure may be saved to the selected destination.

Name group data structures may include a list of names and corresponding unique numbers conforming to a prescribed format of the handheld device 150. The name group data structure may include a single contiguous data structure. The name group data structure may be optimized for the intended handheld device 150 and its delivery method which may include retaining the original names and numeric identifiers when transferred to the removable storage device 142 as well as allowing the contiguous data structure to be deconstructed into its original elements.

The administrative application includes a process which creates well-defined, contiguous data structures. These can be part of a larger name management system where the name group data structures are created as needed and distributed by messaging and content systems in addition to local data repositories. The administrative application may also allow for the creation and management of multiple name groups.

The assignment application and name group data structure may be stored on the removable storage device 142 including a flash memory card of the type used by handheld devices 150 to store information. The assignment application may allow handheld devices 150 to be configured in the absence of a desktop or laptop computer and the device's synchronization program. While the removable storage device 142 may be used to launch the assignment application and install the device names, other data transport methods, including wired and wireless networks and point-to-point protocols such as Infrared may be used if the handheld device 150 has the capability to access data residing on remote storage mechanisms using these networks and protocols.

The assignment application may be used by a user to select device names from the list and configure handheld devices 150 with the selected device names and corresponding unique numeric identifiers. The assignment application may launch when the removable storage device 142 is inserted into the handheld device 150. The assignment application may be configured to automatically install a next unused device name and unique numeric identifier when the removable storage device 142 is inserted into a subsequent handheld device 150.

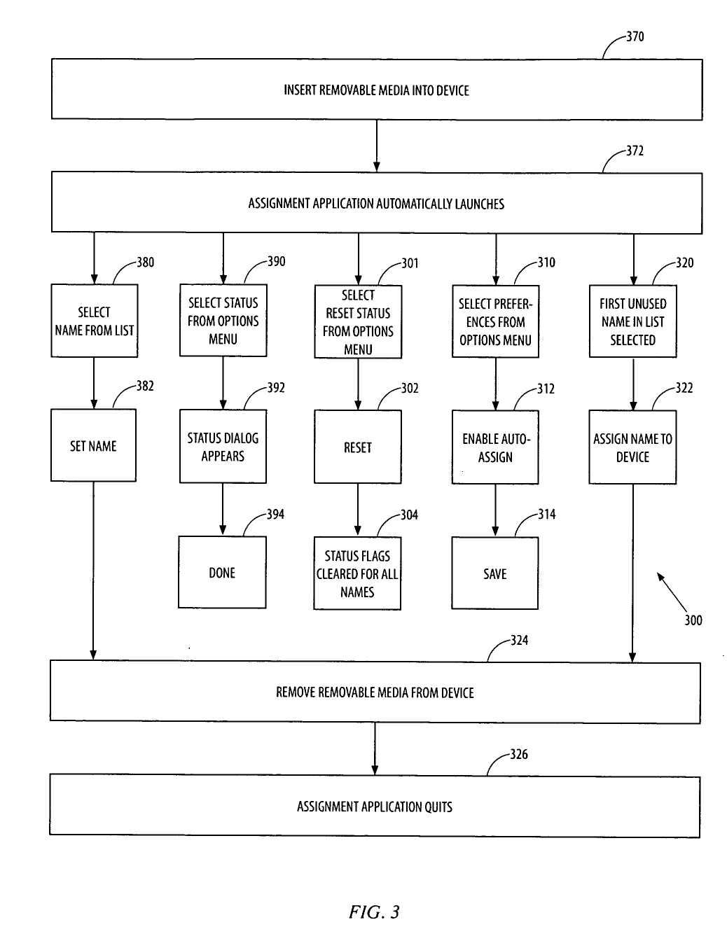

The assignment application may include a process generally designated 300 as shown in FIG. 3 that may be executed by a handheld device processor (not shown). In a step 370 the removable storage device 142 having stored thereon the assignment application and name group data structure may be inserted into the handheld device 150. The handheld device processor may automatically launch the assignment application in a step 372 and display a list of available device names. The user may select from a plurality of processes to select a device name from the list (step 380), select a status of the assignment application (step 390), select a reset status (step 301), select preferences (step 310), and select a first unused device name in the list (step 320).

In a step 380 the user may select a device name from the list. In a step 382 the assignment application may set the selected name by configuring the handheld device 150 with the selected device name and corresponding unique numeric identifier. In a step 324, the removable storage device 142 may be removed from the handheld device 150 and in a step 326 the assignment application may quit.

The user may view the status of the assignment application in a step 390. In a step 392 a status dialog box (not shown) may be displayed to the user. The user may return to the assignment application in a step 394.

To reset the status of all the device names, the user may select a reset status in a step 301. In a step 302 the user may be prompted to confirm the reset action. Status flags may be reset in a step 304.

To assist in configuring large numbers of handheld devices 150, the user may use an auto-assign command by selecting a preferences menu (not shown) in a step 310. The user may enable the auto-assign command in a step 312. This preference may be saved in a step 314.

A next handheld device 150 may be configured with a next unused device name by removing the removable storage device 142 in step 324. The assignment application then quits in step 326. The removable storage device 142 may then be inserted into the next handheld device 150 in step 370 and the assignment application launched in step 372. The assignment application may select the next unused device name in a step 320 and configure the next handheld device 150 with the next unused device name and corresponding unique numeric identifier in a step 322. The removable storage device 142 may then be removed from the next handheld device 150 for insertion into another next handheld device 150.

The user may interrupt the automated installation process by holding down a Page Up key (not shown) as the removable storage device 142 is inserted into the handheld device 150. The assignment application may also allow for the selection of one name group from a list of available name groups and the creation and deletion of device names and unique numeric identifiers from within the assignment application.

The present invention overcomes the disadvantages of the prior art by providing a system and method for providing a user-definable, removable media-based device name assigner including an administrative application for creating and processing device names and unique numeric identifiers into name group data structures for use by an assignment application residing on a removable storage device 142. The assignment application may be used to install and re-install device names and corresponding unique numeric identifiers onto handheld devices in the absence of a desktop or laptop computer.

The foregoing description of the embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

1. A method of installing a device name on a handheld device comprising the steps of:
(a) automatically launching an assignment application on the handheld device from a removable media;
(b) selecting a device name stored on the removable media for installation; and
(c) installing the selected device name on the handheld device using the assignment application.

2. The method of claim 1, wherein the device name comprises a unique numeric identifier.

3. The method of claim 1, wherein the device name is selected from a name group data structure.

4. The method of claim 3, wherein the name group data structure is created by an administrative application.

5. The method of claim 4, wherein the administrative application stores the name group data to the removable media.

6. The method of claim 1, wherein the device names are created individually by an administrative application.

7. The method of claim 1, wherein the device names are created sequentially by an administrative application.

8. The method of claim 1, wherein the device names are created from an external file by an administrative application.

9. The method of claim 8, wherein the external file comprises a comma value separated file.

10. A method of installing device names stored on a removable media onto a plurality of handheld devices comprising the steps of:
(a) automatically launching an assignment application on a first handheld device from the removable media;
(b) selecting a first device name for installation onto the first handheld device using the assignment application;
(c) automatically installing the first device name onto the first handheld device using the assignment application;
(d) selecting an auto-assign function from the assignment application;
(e) automatically launching the assignment application on a next handheld device;
(f) selecting a next device name for installation onto the next handheld device using the assignment application;
(g) automatically installing the next device name onto the next handheld device using the assignment application; and
(h) repeating steps (e)-(g).

11. The method of claim 9, wherein the device names are selected from a name group data structure

12. The method of claim 11, wherein the name group data structure is created by an administrative application.

13. The method of claim 12, wherein the administrative application stores the name group data structure to the removable media.

14. A system for installing a device name on a handheld device comprising:
a processor operable to (a) automatically launch an assignment application on the handheld device from a removable media; (b) select a device name stored on the removable media for installation; and (c) install the selected device name on the handheld device using the assignment application.

15. The system of claim 14, wherein the device name is selected from a name group data structure.

16. The system of claim 15, wherein the name group data structure is created by an administrative application.

17. A system for installing device names stored on a removable media onto a plurality of handheld devices comprising:
a processor operable to (a) automatically launch an assignment application on a first handheld device from the removable media; (b) select a s first device name for installation onto the first handheld device using the assignment application; (c) automatically install the first device name onto the first handheld device using the assignment application; (d) select an auto-assign function from the assignment application; (e) automatically launch the assignment application on a next handheld device; (f) select a next device name for installation onto the next handheld device using the assignment application; (g) automatically install the next device name onto the next handheld device using the assignment application; and (h) repeat steps (e)-(g).

18. The system of claim 17, wherein the device name is selected from a name group data structure.

19. A computer readable medium for installing a device name on a handheld device comprising:
a code segment for automatically launching an assignment application on the handheld device from a removable media;
a code segment for selecting a device name stored on the removable media for installation; and
a code segment for installing the selected device name on the handheld device using the assignment application

20. The computer readable medium of claim 19, wherein the device name is selected from a name group data structure created by an administrative application.
